(19) United States
(12) Patent Application Publication
(10) Pub. No.: US 2019/0233733 A1
(43) Pub. Date: Aug. 1, 2019

(54) CONTROLLING VACUUM IN A HORIZONTAL PAN FILTERING DEVICE

(71) Applicant: Syncrude Canada Ltd., Fort McMurray (CA)

(72) Inventor: XIN ALEX WU, Edmonton (CA)

(21) Appl. No.: 15/886,142

(22) Filed: Feb. 1, 2018

(51) Int. Cl. C10G 1/04; C10G 1/00; C10G 3/00; B01D 33/06

(52) U.S. Cl. CPC C10G 1/045; B01D 33/06; C10G 3/50; C10G 1/002

(57) ABSTRACT

A method for continuously filtering a liquid slurry, such as an oil sand and solvent slurry, in a horizontal pan filtering device is provided. In particular, separate filtrate receivers are built under the wet and the dry sectors of a pan filter to take advantage of the liquid seal at the wet sectors so that the solids in the slurry can be compressed by having a higher vacuum under the wet sectors.

### FIELD OF THE INVENTION

The present invention relates to a method for continuously filtering a liquid slurry, such as an oil sand and solvent slurry, in a horizontal pan filtering device wherein separate filtrate receivers are built under the wet and the dry sectors of the pan filter to take advantage of the liquid seal at the wet sectors. Hence, the solids in the slurry can be compressed by vacuum under the wet sectors.

### BACKGROUND OF THE INVENTION

The present commercial bitumen extraction process for mined oil sands is Clark hot water extraction technology or its variants that use large amounts of water and generate a great quantity of wet tailings. Part of the wet tailings becomes fluid fine tailings (FFT), which contain approximately 30% fine solids and are a great challenge for tailings treatment. In addition, certain “problem” oil sands, often having high fines content, yield low bitumen recoveries in the water-based extraction process. This leads to economic losses and environmental issues with bitumen in wet tailings.

An alternative to water-based extraction is solvent extraction of bitumen from mined oil sands, which uses little or no water, generates no wet tailings, and can potentially achieve higher bitumen recovery than the existing water-based extraction, especially from the aforementioned problem oil sands. Therefore, solvent extraction is potentially more robust and more environmentally friendly than water-based extraction. A number of solvent extraction processes have been proposed [see, for example, U.S. Pat. Nos. 3,117,922, 3,475,318, Canadian Patent 2751719, Canadian Patent 2724806, and Canadian Patent 2895118].

One key step in any solvent extraction process is to rapidly separate the hydrocarbon liquids from the sand matrix. Use of a continuous filter has been proposed, which produces low-hydrocarbon-content filter cakes. To support high throughput, oil sand solids are usually flocculated or agglomerated prior to filtration to make the filter cake highly permeable for the filtrate to pass therethrough. Oil sand filtration typically runs on filter cake with permeability larger than 10⁻¹¹ m² while almost all other filtration applications run on filter cakes with permeability smaller than 10⁻¹² m² [see, for example, S. Ripperger, W. Gosele, C. Alt, “Filtration, 1. Fundamentals”, Ullmann's Encyclopedia of Industrial Chemistry, Vol. 14, pp. 682 (FIG. 5), 7^{th} Edition, Wiley-VCH].

The highly permeable oil sand filter cake has a unique deliquoring feature on a continuous top-loading filter, e.g. a pan filter, which allows very fast drainage of slurry liquid at the beginning but has a long tail of liquid dripping after overhead gas breaks through the cake. This long tail of drainage reduces the filter throughput or negatively affect the filter wash efficiency and bitumen recovery if the tail is truncated in operation. This drainage feature is caused by high gas flow in the gas breakthrough sectors of the filter that leads to low vacuum and low compression on the filter cake in all filter sectors.

The conventional way of operating a continuous filter is to have a single vacuum source with a single mode of control, e.g., maintaining a fixed pressure in the vacuum line, a fixed gas flow rate in the vacuum line, or a fixed vacuum pump power output, for all filter sectors. Occasionally, multiple vacuum sources are used due to the capacity limit of a single source. However, the grouping of filter sectors to different vacuum sources is not selective based on their drainage features and a single control mode is used for all vacuum sources. These types of vacuum control are not an issue for low-permeable filter cakes in many filtration applications since the low-permeable cakes provide a reasonable “seal” to limit gas breakthrough. However, for high-permeable cakes, for example, such as those produced in oil sand application, the high gas flow in the breakthrough sectors causes large “leakage” that prevent any significant vacuum to form.

Therefore, there is a need in the industry for a better way to control a filter vacuum when using filtration to separate liquor from highly permeable cakes, e.g., hydrocarbon liquids from sand in solvent extraction processes, in particular, when high throughputs are required.

### SUMMARY OF THE INVENTION

The present invention relates to a method for continuously filtering a liquid slurry, such as an oil sand and solvent slurry, in a horizontal pan filtering device wherein separate filtrate receivers are built under the wet and the dry sectors of the pan filter to take advantage of the liquid seal at the wet sectors. Hence, the solids in the slurry can be compressed by vacuum under the wet sectors.

Broadly stated, in one aspect of the present invention, a method for continuously filtering a liquid slurry is provided, the method comprising:
providing a horizontal pan filtering device having a rotatable filter support for holding a pan filter, the pan filter comprising a slurry feed section, a first filtrate drainage section having a wet sector and a dry sector, a second filtrate drainage section having a wet sector and a dry sector, and a filter cake discharge section, all sections having a common rotatable screen bottom to prevent solids from passing therethrough;
depositing the slurry onto the slurry feed section of the pan filter and rotating the filter support until the slurry reaches the wet sector of the first filtrate drainage section;
drawing a vacuum at the wet sector of the first filtrate drainage section with a first vacuum source to draw the liquid through the filter to form a first filtrate and drained slurry;
rotating the filter support until the drained slurry reaches the dry sector of the first filtrate drainage section;
drawing a vacuum at the dry sector of the first filtrate drainage section with a second vacuum source to draw the liquid through the filter and form a second filtrate and a first filter cake;
rotating the filter support until the first filter cake reaches the wet sector of the second filtrate drainage section where it is washed with a liquid to form a washed first filter cake;
drawing a vacuum at the wet sector of the second filtrate drainage section with a third vacuum source to draw the liquid through the filter to form a third filtrate and drained washed first filter cake;
rotating the filter support until the drained washed first filter cake reaches the dry sector of the second filtrate drainage section;
drawing a vacuum at the dry sector of the second filtrate drainage section with a fourth vacuum source to draw the liquid through the filter to form a fourth filtrate and a second filter cake; and
removing the second filter cake from the filter cake discharge section;
whereby the first vacuum source and the third vacuum source are capable of generating a higher vacuum than the second vacuum source and the fourth vacuum source.

In one embodiment, the first vacuum source and the third vacuum source are the same vacuum source. In another embodiment, the second vacuum source and the fourth vacuum source are the same vacuum source. In one embodiment, the horizontal pan filtering device further comprises an enclosure box for enclosing the pan filter, which enclosure box does not rotate. In one embodiment, inert gas flows continuously into the enclosure box to maintain a gas pressure at or near atmospheric pressure. In one embodiment, the inert gas is recycled inert gas from the exhaust of all vacuum sources.

In one embodiment, the slurry comprises oil sand and a mixture of a high-flash point heavy solvent (HS) and a light solvent (LS). In one embodiment, the mass ratio of HS/LS is controlled to be in the range of about 75/25 to about 40/60 to ensure little to no asphaltene precipitation.

The heavy solvent may be a light gas oil stream, i.e. a distillation fraction of oil sand bitumen, of mixed C₉ to C₃₂ hydrocarbons with a boiling range within about 130-470° C. The light end boiling point is below about 170° C. The contaminant content originating from a naphtha stream in the upgrader is less than about 5 wt %. It has a flash point of about 90° C. in air. The light solvent may be a mixed aliphatic and aromatic hydrocarbon stream C₆-C₁₀ with a boiling range of 69-170° C., which light solvent is available from bitumen upgrading units. The preferred LS is C₆-C₇ with a boiling range of 69-110° C.

In one embodiment, the solvent is a light solvent only. It is a mixed aliphatic and aromatic hydrocarbon stream C₆-C₁₀ with a boiling range of 69-170° C.

### BRIEF DESCRIPTION OF THE DRAWINCIS

The invention will now be described by way of an exemplary embodiment with reference to the accompanying simplified, diagrammatic, not-to-scale drawings:

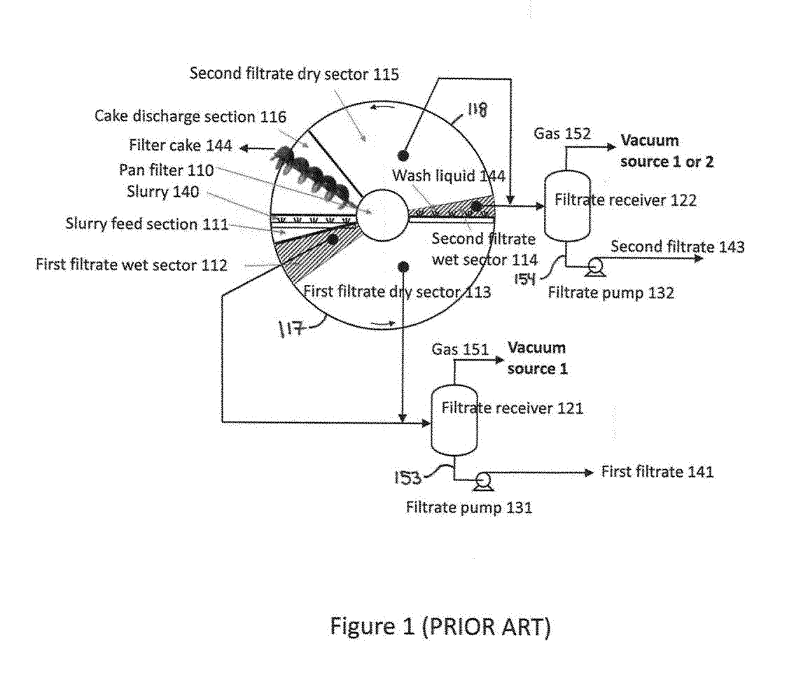

FIG. 1 is a schematic process flow diagram of a solvent extraction process of the present invention.

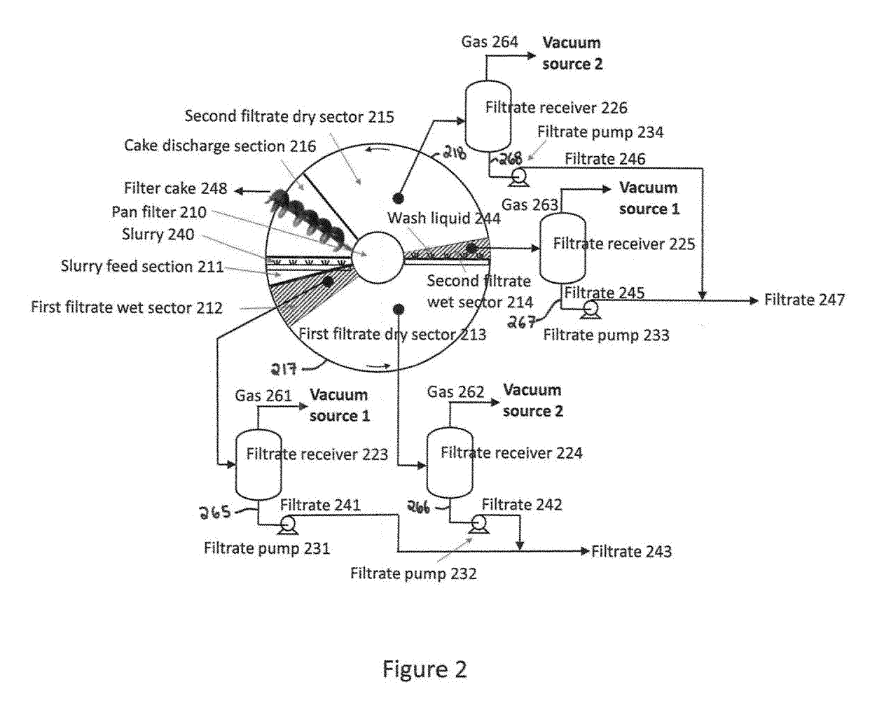

FIG. 2 is a schematic diagram of a baffled tank agitated with impellers useful in the present invention.

### DETAILED DESCRIPTION OF PREFERRED EMBODIMENTS

The detailed description set forth below in connection with the appended drawings is intended as a description of various embodiments of the present invention and is not intended to represent the only embodiments contemplated by the inventors. The detailed description includes specific details for the purpose of providing a comprehensive understanding of the present invention. However, it will be apparent to those skilled in the art that the present invention may be practised without these specific details.

The present invention relates generally to a method for continuously filtering a liquid slurry using a horizontal pan filtering device. Generally, when using a continuous filter, the slurry liquid at the slurry feed location usually overruns on the surface of the draining slurry for a short distance before being drained through the filter cake that is being formed (generally referred to herein as the “wet sector” of the pan filter). It was discovered that this overrunning liquid provides a “seal”, particularly with high-permeable filter cakes, and that the seal can be used to generate a higher vacuum in the filtrate receiver below the seal, i.e., in the wet sectors of the pan filter.

It was surprisingly discovered by the present applicant that filter cake that has been briefly compressed by a higher vacuum yields better drainage performance later with a smaller drainage tail than filter cake that has never been exposed to any significant vacuum. In the prior art, filter sectors, with or without this liquid seal, are generally grouped together and linked to the same vacuum source. The gas leakage through the dry sectors that have no liquid seals prevents any significant vacuum to form, even under the wet sectors with the liquid seal. In this invention, separate filtrate receivers are built under the wet and the dry sectors of a pan filter to take advantage of the liquid seal at the wet sectors. Hence, filter cake can be compressed by vacuum under the wet sectors.

Horizontal pan filtering devices, also known as table filters, are known in the art. Generally, a horizontal pan filtering device comprises a rotatable filter support for holding the pan filter. Underneath the pan filter are many fixed pie-shaped segments with separation walls and a filtrate drainage pipe attached to the bottom of each segment. Some of the segments are blocked under their screen area to form slurry feed section, cake discharge section, etc. Other segments are open to the draining slurry or filter cakes to form filtrate drainage sections. The pipes from the open segments may be joined together in one or multiple groups and attached to at least one filtrate receiver having a vacuum source for collecting the liquid present in a liquid slurry (“filtrate”). There may exist more than one filtrate receiver but generally all filtrate receivers are controlled by the same vacuum.

FIG. 1 is a schematic of a prior art pan filter wherein a continuous pan filter rotating counter-clockwise is used for solid-liquid separation. The pan filter 110 has four basic sections: slurry feed section 111, first filtrate drainage section 117, second filtrate drainage section 118 and cake discharge section 116. Each section comprises a single or multiple pie-shaped screen segment(s). The number of segments depends on the size of each segment in a certain pan filter. In one embodiment, the screens are made of wedge-wire slots of 100 pm in width. Slurry feed section 111 and cake discharge section 116 are blocked off below their screen sections and do not allow any drainage. First filtrate drainage section 117 contains wet sector 112 and dry sector 113. The wet sector 112 is at a location where slurry liquid from a slurry feed stream 140 completely covers the surface of the filter cake. The dry sector is located where no liquid remains on the surface of the filter cake and overhead gas breaks through the cake. Similarly, the second filtrate drainage section 118 contains wet sector 114 and dry sector 115. The source of the liquid is a wash liquid stream 144. Each wet or dry sector comprises one or multiple fixed segment(s) under the screen. The number of segments depends on the size of each segment and the draining characteristics of the slurry or the filter cake of a certain application.

Filtrate mixed with gas generated in both wet sector 112 and dry sector 113 flows into a single filtrate receiver 121 where gas and liquid separate. The liquid stream 153 is pumped out with filtrate pump 131 to become first filtrate stream 141. The gas stream 151 is sucked into a vacuum line that is connected to vacuum source 1. Filtrate mixed with gas generated in both wet sector 114 and dry sector 115 flows into a single filtrate receiver 122 where gas and liquid separate. The liquid stream 154 is pumped out with filtrate pump 132 to become second filtrate stream 143. The gas stream 152 is sucked into the same vacuum line as stream 151 that is connected to vacuum source 1. Alternately, the gas stream 152 is sucked into a separate vacuum source (vacuum source 2). In either case, vacuum sources 1 and 2 are both exposed to dry sectors with large amounts of gas breaking through the filter cake and thus are difficult to achieve significant vacuum for highly permeable filter cakes. Hence, the filter cake has never been compressed to yield optimal drainage performance.

FIG. 2 shows one embodiment of the present invention wherein a continuous pan filter rotating counter-clockwise is used for solid-liquid separation. The pan filter 210 has four basic sections: slurry feed section 211, first filtrate drainage section 217, second filtrate drainage section 218 and cake discharge section 216. Each section comprises a single or multiple pie-shaped screen segments(s). The number of segments depends on the size of each segment in a certain pan filter. In one embodiment, the screens are made of wedge-wire slots of 100 pm in width. Slurry feed section 211 and cake discharge section 216 are blocked off below their screen sections and do not allow any drainage. First filtrate drainage section 217 contains wet sector 212 and dry sector 123. The wet sector 212 is located where slurry liquid from a slurry feed stream 240 completely covers the surface of the filter cake. The dry sector 213 is located where no liquid remains on the surface of the filter cake and overhead gas breaks through the cake. Similarly, the second filtrate drainage section 218 contains wet sector 214 and dry sector 215. The source of the liquid is a wash liquid stream 244. Each wet or dry sector comprises one or multiple fixed segment(s) under the screen. The number of segments depends on the size of each segment and the draining characteristics of the slurry or the filter cake of a certain application. In one embodiment, dry sectors contain more fixed segments than wet sectors.

Filtrate mixed with gas generated in wet sector 212 flows into a filtrate receiver 223 where gas and liquid separate. The liquid stream 265 is pumped out with filtrate pump 231 to become first filtrate stream 241. The gas stream 261 is sucked into a vacuum line that is connected to vacuum source 1. In one embodiment, the vacuum source 1 is a vacuum blower or a vacuum pump that generates −10 to −40 kPa vacuum. Filtrate mixed with gas generated in dry sector 213 flows into a filtrate receiver 224 where gas and liquid separate. The liquid stream 266 is pumped out with filtrate pump 232 to become second filtrate stream 242. The gas stream 262 is sucked into a vacuum line that is connected to vacuum source 2. In one embodiment, the vacuum source 2 is a vacuum blower that generates weak vacuum of −1 to −20 kPa, but is capable of delivering large gas flow. Filtrate streams 241 and 242 may be combined to become filtrate stream 243.

Filtrate mixed with gas generated in wet sector 214, after washed with wash liquid 244, flows into a filtrate receiver 225 where gas and liquid separate. The liquid stream 267 is pumped out with filtrate pump 233 to become third filtrate stream 245. The gas stream 263 is sucked into the same vacuum line as gas stream 261 that is connected to vacuum source 1. Filtrate mixed with gas generated in dry sector 215 flows into a filtrate receiver 226 where gas and liquid separate. The liquid stream 268 is pumped out with filtrate pump 234 to become fourth filtrate stream 246. The gas stream 264 is sucked into the same vacuum line as gas stream 262 that is connected to vacuum source 2. Filtrate streams 245 and 246 may be combined to become filtrate stream 247. After the second filtrate drainage, the filter cake comprising spent solids is cut with a scroll and discharged as filter cake 248.

In one embodiment, vacuum sources 1 and 2 in FIG. 2 are controlled with different control logics. The vacuum source 1 is controlled by maintaining a constant pressure in the vacuum line to achieve its primary goal of compressing the filter cake. The vacuum source 2 is controlled by maintaining a constant gas flow rate in the vacuum line to regulate the amounts of gas breaking through the filter cake. In solvent extraction of oil sand bitumen, filters are enclosed to provide an inert atmosphere for safe operations. The inert gas, e.g. nitrogen, is recycled back to the filter enclosure after going through the filter cake and the vacuum source. Prior to recycling, the gas needs to be cooled and separate out the condensed solvent and water. If the amounts of gas breaking through the filter cake is excessive, it will overwhelm the recycle gas treatment equipment. When the filter cake permeability becomes higher than normal (normal: 10⁻¹¹ to 10⁻¹⁰ m²) under an upset condition, single vacuum control logic by maintaining a constant pressure generates excessive amounts of gas. When the filter cake permeability becomes lower than normal under another upset condition, single vacuum control logic by maintaining a constant gas flow rate generates excessive vacuum and compression, and further tightens the cake to make recovery of the filter operation difficult.

Therefore, if there is only a single vacuum source or multiple but non-selective vacuum sources, it cannot satisfy the conflicting demands regardless of the choice of control logic. In the present invention, it was surprisingly discovered that using different vacuum control logics, as mentioned above, solves this problem. When the cake permeability is higher than normal, vacuum source 2 with constant flow control regulates the gas flow rate, and vacuum source 1 with constant pressure control is unable to generate large gas flow due to the liquid seal on the cake surface. When the cake permeability is lower than normal, vacuum source 1 with constant pressure control regulates the compression of the cake, and vacuum source 2 with constant flow control is unable to generate higher vacuum due to limitation of the vacuum generator selected for this source that is only capable of high gas flow but weak vacuum.

In one embodiment, the slurry feed 240 is comprised of oil sand, a heavy solvent and a light solvent as taught in CA Patents 2,751,719 and 2,895,118. In one embodiment, the wash liquid 244 is comprised of a heavy solvent and a light solvent as taught in CA Patents 2,751,719 and 2,895,118. In one embodiment, the discharged filter cake 248 goes into a repulper to mix with more light solvent as taught in CA Patents 2,751,719 and 2,895,118. The repulped slurry is fed onto a second filter with similar vacuum control as in FIG. 2.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

What is claimed is:

1. A method for continuously filtering a liquid slurry, comprising:
(a) providing a horizontal pan filtering device having a rotatable filter support for holding a pan filter, the pan filter comprising, in order, a slurry feed section, a first filtrate drainage section having a wet sector and a dry sector, a second filtrate drainage section having a wet sector and a dry sector, and a filter cake discharge section, all sections having a common rotatable screen bottom to prevent solids from passing therethrough;
(b) depositing the slurry onto the slurry feed section of the pan filter and rotating the filter support until the slurry reaches the wet sector of the first filtrate drainage section;
(c) drawing a vacuum at the wet sector of the first filtrate drainage section with a first vacuum source to draw the liquid through the filter to form a first filtrate and drained slurry;
(d) rotating the filter support until the drained slurry reaches the dry sector of the first filtrate drainage section;
(e) drawing a vacuum at the dry sector of the first filtrate drainage section with a second vacuum source to draw the liquid through the filter and form a second filtrate and a first filter cake;
(f) rotating the filter support until the first filter cake reaches the wet sector of the second filtrate drainage section where it is washed with a liquid to form a washed first filter cake;
(g) drawing a vacuum at the wet sector of the second filtrate drainage section with a third vacuum source to draw the liquid through the filter to form a third filtrate and drained washed first filter cake;
(h) rotating the filter support until the drained washed first filter cake reaches the dry sector of the second filtrate drainage section;
(i) drawing a vacuum at the dry sector of the second filtrate drainage section with a fourth vacuum source to draw the liquid through the filter to form a fourth filtrate and a second filter cake; and
(j) removing the second filter cake from the filter cake discharge section;
whereby the first vacuum source and the third vacuum source are capable of generating a higher vacuum than the second vacuum source and the fourth vacuum source.

2. The method as claimed in claim 1, wherein the first vacuum source and the third vacuum source are the same vacuum source.

3. The method as claimed in claim 2, wherein the second vacuum source and the fourth vacuum source are the same vacuum source.

4. The method as claimed in claim 1, the first vacuum source and the third vacuum source each comprise a vacuum line, wherein the first and third vacuum sources are each controlled by maintaining a constant pressure in their respective vacuum lines to compress the drained slurry and drained washed first filter cake, respectively.

5. The method as claimed in claim 1, the second vacuum source and the fourth vacuum source each comprise a vacuum line, wherein the second and fourth vacuum sources are each controlled by maintaining a constant gas flow rate in their respective vacuum lines to regulate the amount of gas breaking through the first filter cake and the second filter cake, respectively.

6. The method as claimed in claim 4, wherein the pressure in the first and the third vacuum sources is controlled to be in the range of −10 to −40 kPa.

7. The method as claimed in claim 5, wherein the pressure in the second and the fourth vacuum sources is in the range of −1 to −20 kPa.

8. The method as claimed in claim 1, wherein the horizontal pan filtering device further comprises an enclosure box that does not rotate for sealing the horizontal pan filtering device.

9. The method as claimed in claim 8, wherein inert gas flows continuously into the enclosure box to maintain a gas pressure therein of near atmospheric pressure.

10. The method as claimed in claim 9, wherein the inert gas is inert gas recycled from exhaust of all vacuum sources.

11. The method as claimed in claim 1, wherein the liquid slurry comprises oil sand and a mixture of a high-flash point heavy solvent (HS) and a light solvent (LS).

12. The method as claimed in claim 11, wherein the mass ratio of HS/LS is controlled to be in the range of about 75/25 to about 40/60.

13. The method as claimed in claim 11, wherein HS is a light gas oil stream of mixed C₉ to C₃₂ hydrocarbons with a boiling range within about 130-470° C.

14. The method as claimed in claim 11, wherein LS is a mixed aliphatic and aromatic hydrocarbon stream C₆-C₁₀ with a boiling range of 69-170° C.

15. The method as claimed in claim 14, wherein LS is a mixed aliphatic and aromatic hydrocarbon stream C₆-C₇ with a boiling range of 69-110° C.

16. The method as claimed in claim 1, wherein the liquid slurry comprises oil sand and a light solvent.

17. The method as claimed in claim 16, wherein the light solvent is a mixed aliphatic and aromatic hydrocarbon stream C₆-C₁₀ with a boiling range of 69-170° C.
